(19) United States
(12) Patent Application Publication
(10) Pub. No.: US 2025/0174775 A1
(43) Pub. Date: May 29, 2025

(54) SECONDARY BATTERY

(71) Applicant: Samsung SDI Co., Ltd., Yongin-si (KR)

(72) Inventor: Young Gwang CHOI, Yongin-si (KR)

(21) Appl. No.: 18/642,538

(22) Filed: Apr. 22, 2024

(30) Foreign Application Priority Data
Nov. 24, 2023 (KR) 10-2023-0165288

(51) Int. Cl. H01M 50/136; H01M 50/103

(52) U.S. Cl. CPC H01M 50/136; H01M 50/103

(57) ABSTRACT

The present disclosure relates to a secondary battery having a case with reinforced rigidity. The secondary battery includes: an electrode assembly including a first electrode plate, a second electrode plate, and a separator; a case accommodating the electrode assembly; and a reinforcement unit having a recessed or protruding shape on the outer side surface of the case.

### CROSS-REFERENCE TO RELATED APPLICATION

The present application claims priority to and the benefit of Korean Patent Application No. 10-2023-0165288, filed on Nov. 24, 2023, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be recharged, a secondary battery can be repeatedly charged and discharged. Low-capacity batteries in which a single battery cell is packaged in a pack are used in small, portable electronic devices such as mobile phones and camcorders, while high-capacity battery modules in the form of battery packs having dozens of battery packs connected are widely used as a power source for driving motors in hybrid vehicles and electric vehicles.

A secondary battery may be constructed by incorporating an electrode assembly and an electrolyte formed with a separator interposed between a positive electrode plate and a negative electrode plate in a case, and installing a cap plate on the case. The electrode assembly may be a wound type or a stack type. The electrode assembly may have an uncoated tab portion protruding upward or laterally, and a current collection member may be connected to the uncoated tab portion.

The above information disclosed in this Background section is only for enhancement of understanding of the background of the disclosure and therefore it may contain information that does not constitute prior art.

### SUMMARY

The present disclosure relates to various embodiments of a secondary battery having a case with reinforced rigidity.

The secondary battery may include recesses and/or protrusions on the surface of the case to provide the reinforced rigidity.

These and other aspects and features of the present disclosure will be described in or will be apparent from the following description of embodiments of the present disclosure.

A secondary battery according to an embodiment of the present disclosure may include: an electrode assembly including a first electrode plate, a second electrode plate, and a separator; a case accommodating the electrode assembly; and a reinforcement unit having a recessed or protruding shape on an outer side surface of the case.

The reinforcement unit may include: a first reinforcement member having a first pattern on the outer side of the case in a recessed or protruding shape; and a second reinforcement member having a second pattern on the outer side of the case in a different shape from the first reinforcement member.

The first reinforcement member and the second reinforcement member may both include protrusions protruding from the outer side of the case.

The first reinforcement member may include a cross-shaped or X-letter shaped protrusion.

The second reinforcement member may include two or more protrusions on the outer side of the first reinforcement member.

The second reinforcement member may include two or more protrusions bent in a inverse L-letter (¬) and L-letter shapes.

The second reinforcement member may include two or more second reinforcement members and the size of the second reinforcement members may gradually increase in a direction toward the center of the first reinforcement member.

The first reinforcement member and the second reinforcement member may be formed on multiple sides of the outer side surface of the case.

Widths of the first reinforcement member and the second reinforcement member may be in a range from approximately 0.1 mm to approximately 30 mm, and depths of the first reinforcement member and the second reinforcement member may be in a range from approximately 0.05 mm to approximately 5 mm.

A secondary battery according to an embodiment of the present disclosure may include: an electrode assembly including a first electrode plate, a second electrode plate, and a separator; a case accommodating the electrode assembly; and a reinforcement unit that forms a reinforcement member on the outer side surface of the case. The reinforcement member may extend in the lengthwise or upward-and-downward direction of the case.

The reinforcement member may include two or more protrusions extending in the lengthwise direction of the case and protruding outward from the case.

The reinforcement member may include two or more protrusions extend in the upward-and-downward direction of the case and protruding outward from the case.

A secondary battery according to an embodiment of the present disclosure may include: an electrode assembly including a first electrode plate, a second electrode plate, and a separator; a case accommodating the electrode assembly; and a reinforcement unit that includes two or more reinforcement members protruding outward from the outer side surface of the case.

The reinforcement members may include circular or straight-shaped protrusions.

The reinforcement members may be circular protrusions.

The reinforcement members may be arranged in a cross or X-letter shape.

The reinforcement members may be circular protrusions.

The reinforcement members may be arranged in rows and columns within a rectangular area.

The reinforcement members at the corners of the central rectangular area may be smaller in size than other reinforcement members not installed at the corners of the rectangular area.

The height at which the reinforcement members protrude from the case may be in a range from approximately 0.05 mm to approximately 5 mm.

The reinforcement unit may include two or more reinforcement members including protrusions extending in the horizontal direction.

The reinforcement members may be arranged in rows and columns within a rectangular area.

The reinforcement members may be on multiple outer side surfaces of the case.

### BRIEF DESCRIPTION OF DRAWINGS

The following drawings attached to this specification illustrate preferred embodiments of the present disclosure, and serve to further understand the technical idea of the present disclosure together with the detailed description of the invention to be described later, and thus the present disclosure should not be construed as limited to the matters described in the drawings.

FIG. 1 is a perspective view of a secondary battery according to a first embodiment of the present disclosure.

FIG. 2 is a cross-sectional view of the secondary battery according to the first embodiment of the present disclosure.

FIG. 3 is a perspective view showing a case and a reinforcement unit, according to the first embodiment of the present disclosure.

FIG. 4 is a front view showing the case and the reinforcement unit, according to the first embodiment of the present disclosure.

FIG. 5 is a diagram showing swelling changes according to the safety performance test of the case, according to the first embodiment of the present disclosure.

FIG. 6 is a front view showing a case and a reinforcement unit, according to a second embodiment of the present disclosure.

FIG. 7 is a perspective view showing a case and a reinforcement unit, according to a third embodiment of the present disclosure.

FIG. 8 is a front view showing the case and the reinforcement unit, according to the third embodiment of the present disclosure.

FIG. 9 is a diagram showing swelling changes according to the safety performance test of the case according to the third embodiment of the present disclosure.

FIG. 10 is a front view showing a case and a reinforcement unit, according to a fourth embodiment of the present disclosure.

FIG. 11 is a diagram showing swelling changes according to the safety performance test of the case according to the fourth embodiment of the present disclosure.

FIG. 12 is a front view showing a case and a reinforcement unit, according to a fifth embodiment of the present disclosure.

FIG. 13 is a diagram showing swelling changes according to the safety performance test of the case according to the fifth embodiment of the present disclosure.

FIG. 14 is a front view showing a case and a reinforcement unit, according to a sixth embodiment of the present disclosure.

FIG. 15 is a front view showing a case and a reinforcement unit, according to a seventh embodiment of the present disclosure.

FIG. 16 is a front view showing a case and a reinforcement unit, according to an eighth embodiment of the present disclosure.

FIG. 17 is a front view showing a case and a reinforcement unit, according to a ninth embodiment of the present disclosure.

FIG. 18 is a front view showing a case and a reinforcement unit, according to a tenth embodiment of the present disclosure.

FIG. 19 is a perspective view showing a case and a reinforcement unit, according to an eleventh embodiment of the present disclosure.

### DETAILED DESCRIPTION

Hereinafter, embodiments of the present disclosure will be described in detail with reference to the accompanying drawings.

Embodiments of the present disclosure are provided to more fully describe the present disclosure to those skilled in the art, and the following embodiments may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout. In addition, it will be understood that when an element A is referred to as being “connected to” an element B, the element A can be directly connected to the element B or an intervening element C may be present therebetween such that the element A and the element B are indirectly connected to each other. As used herein, the term “and/or” includes any and all combinations of one or more of the associated listed items.

The terminology used herein is for the purpose of describing particular embodiments only and is not intended to be limiting of the disclosure.

As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, preferred embodiments of the present disclosure will be described in detail with reference to the attached drawings. Prior to describing the present disclosure, terms or words used in present specification and claims are not to be limitedly interpreted as general or dictionary meanings and should be interpreted as meanings and concepts that are consistent with the technical idea of the present invention on the basis of the principle that an inventor may properly define concepts of terms to describe his or her invention in the best way. Therefore, the embodiments described in this specification and the configurations shown in the drawings are only some of the most preferred embodiments of the present disclosure and do not represent all of the technical spirit of the present disclosure, so it should be understood that there may be various equivalents and variations that can be substituted for these at the time of this application. In addition, as used herein, the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

In addition, for a better understanding of the present disclosure, the accompanying drawings may not be drawn to scale, and dimensions of some components may be exaggerated. In addition, the same reference numbers may be assigned to the same components in different embodiments.

A reference to two comparable objects being “the same” means that they are “substantially the same”. Thus, the wording “substantially the same” may include a case of having a deviation that is considered low in the art, for example, a deviation of 5% or less. In addition, being uniform in a certain parameter in a predetermined region may mean that the parameter is uniform in terms of average.

It will be understood that, although the terms first, second, etc. may be used herein to describe various members, elements, regions, layers and/or sections, these members, elements, regions, layers and/or sections should not be limited by these terms.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked”, “coupled” or “connected” to another component, these components may be directly linked or connected to each other, but another component may be “interposed” between the components”, or the respective components may also be “linked”, “coupled” or “connected” through another component.

Throughout the specification, when referring to “A and/or B”, this means A, B or A and B, unless otherwise stated, and when referring to “C to D”, this means that it is more than C and less than D, unless otherwise stated.

A secondary battery 100 according to embodiments of the present disclosure will be described with reference to the drawings.

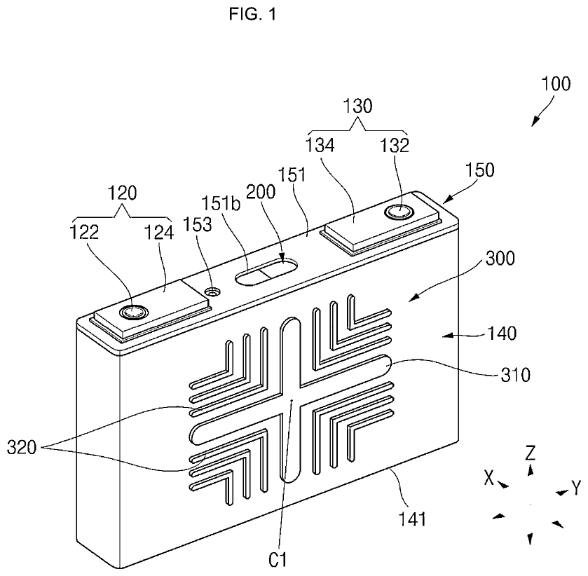

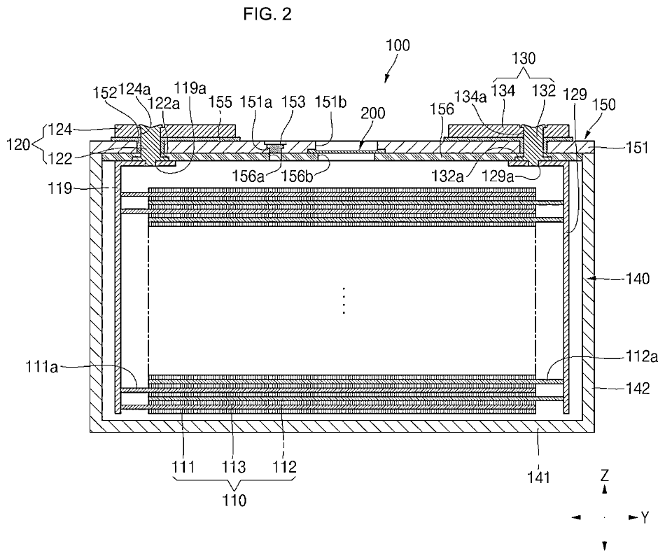

FIG. 1 is a perspective view of a secondary battery 100 according to a first embodiment of the present disclosure, and FIG. 2 is a cross-sectional view of the secondary battery 100 according to the first embodiment of the present disclosure. As shown in FIGS. 1 and 2, the secondary battery 100 includes an electrode assembly 110, a case 140, and a reinforcement unit 300. In addition, the secondary battery 100 according to the first embodiment of the present disclosure may further include at least one of a first current collection part, a first terminal, a second current collection part, a second terminal, a cap assembly, and a safety vent.

The electrode assembly 110 may be formed by winding or stacking a laminate of the first electrode plate 111, the separator 113, and the second electrode plate 112, which are formed in a thin plate or film shape. In an embodiment in which the electrode assembly 110 is a wound laminate, the winding axis may be parallel (or substantially parallel) to the lengthwise direction (y) of the case 140. In addition, the electrode assembly 110 may be a stack type rather than a wound type, and the present disclosure is not limited to a particular shape of the electrode assembly 110. In addition, the electrode assembly 110 may be a Z-stack electrode assembly 110 in which the positive and negative electrode plates are inserted into both sides of the separator 113 and bent into a Z-stack type. In addition, the electrode assembly 110 may be accommodated inside the case 140 by stacking one or more electrode assemblies 110 so that long side surfaces 142 are adjacent to each other. The present disclosure does not limit the number of electrode assemblies 110. The first electrode plate 111 of the electrode assembly 110 may serve as a negative electrode, and the second electrode plate 112 may serve as a positive electrode. The first electrode plate of the electrode assembly 110 may serve as a positive electrode, and the second electrode plate 112 may serve as a negative electrode.

The first electrode plate 111 is formed by applying a first electrode active material such as graphite or carbon to a first electrode current collector plate formed of a metal foil such as copper, a copper alloy, nickel, or a nickel alloy, and may include a first electrode tab 111a (or a first uncoated portion), which is a region to which the first electrode active material is not applied. The first electrode tab 111a may be a path for current flow between the first electrode plate 111 and the first current collection part 119. In one or more embodiments, the first electrode tab 111a may be formed by cutting the metal foil to protrude on one side during manufacturing of the first electrode plate 111, and may protrude further on one side than the separator 113 without separate cutting. In one or more embodiments, a plurality of first electrode tabs 111a are collected and tack-welded, and the first current collection part 119 is welded to the tack-welded first electrode tabs 111a, and thus can be coupled to each other.

The second electrode plate 112 is formed by applying a second electrode active material such as a transition metal oxide to a second electrode current collector formed of a metal foil such as aluminum or an aluminum alloy, and may include a second electrode tab 112a (or a second uncoated portion), which is a region to which the second electrode active material is not applied. The second electrode tab 112a may be a path for current flow between the second electrode plate 112 and the second current collection part 129. In one or more embodiments, the second electrode tab 112a may be formed by cutting the metal foil to protrude on the other side during manufacturing of the second electrode plate 112, and may protrude further toward the other side than the separator 113 without separate cutting. In one or more embodiments, a plurality of second electrode tabs 112a are collected and tack-welded, and a second current collection part 129 is welded to the tack-welded second electrode tabs 112a, and thus can be coupled to each other.

In one or more embodiments, the first electrode tab 111a may be located on the left end side surface 142 of the electrode assembly 110, and the second electrode tab 112a may be located on the right end side surface 142 of the electrode assembly 110. In one or more embodiments, the first electrode tab 111a and the second electrode tab 112a may be located on one side of the same direction (e.g., the Y-direction). As used herein, the left and right sides are for convenience of explanation on the basis of the secondary battery 100 shown in FIG. 1, and the location may change when the secondary battery 100 is rotated left and right or up and down.

The first electrode tab 111a of the first electrode plate 111 and the second electrode tab 112a of the second electrode plate 112 are located at opposite ends of the electrode assembly 110. In one or more embodiments, the electrode assembly 110 may be accommodated in the case 140 along with an electrolyte. In addition, in the electrode assembly 110, the first current collection part 119 and the second current collection part 129 are welded and connected to the first electrode tab 111a of the first electrode plate 111 and the second electrode tab 112a of the second electrode plate 112, respectively.

In one or more embodiments, the separator 113 is located between the first electrode plate 111 and the second electrode plate 112 and serves to prevent short circuits and enable the movement of lithium ions. The separator 113 may include polyethylene, polypropylene, or a composite film of polyethylene and polypropylene. In one or more embodiments, the separator 113 may be replaced with an inorganic solid electrolyte such as a sulfide-based, oxide-based, or phosphate-based electrolyte that does not require a liquid or gel electrolyte.

The first current collection part 119 and the second current collection part 129, which are electrically connected to the first electrode tab 111a of the first electrode plate 111 and the second electrode tab 112a of the second electrode plate 112, respectively, are located at opposite ends of the electrode assembly 110. In one or more embodiments, the electrode assembly 110 may be accommodated in the case along with an electrolyte.

In one or more embodiments, the electrolyte may include a lithium salt such as LiPF6 or LiBF4 in an organic solvent such as EC, PC, DEC, EMC, or DMC. In addition, the electrolyte may be in a liquid or gel phase. In one or more embodiments, when an inorganic solid electrolyte is used, the electrolyte may be omitted.

In one or more embodiments, the first current collection part 119 may be in contact with the first electrode tab 111a protruding from one end of the electrode assembly 110. In one or more embodiments, the first current collection part 119 may be welded to the first electrode tab 111a. In one or more embodiments, the first current collection part 119 is formed in an approximately inverse L (“¬”)-letter shape, and a terminal hole 119a may be formed at the top. In one or more embodiments, the first terminal pillar 122 may be inserted into the terminal hole 119a and riveted and/or welded. In one or more embodiments, the first current collection part 119 may be made of copper or a copper alloy.

The first terminal 120 is made of metal and may be electrically connected to the first electrode plate 111 through the first current collection part 119. In one or more embodiments, the first terminal 120 may include a first terminal pillar 122 and a first terminal plate 124.

In one or more embodiments, the first terminal pillar 122 may pass through a cap plate 151 of the cap assembly 150 and protrude and extend upward for a certain length and may be electrically connected to the first current collection part 119 at the lower portion of the cap plate 151. In addition, in one or more embodiments, the first terminal pillar 122 protrudes and extends a certain length upward from the upper part of the cap plate 151, and a flange 122a may be formed at a lower portion of the cap plate 151 to prevent the first terminal pillar 122 from falling out of the cap plate 151. The region of the first terminal pillar 122, located below the flange 122a, may be inserted into the first terminal hole 119a of the first current collection part 119 and then riveted and/or welded. In one or more embodiments, the first terminal pillar 122 may be made of copper, a copper alloy, aluminum, or an aluminum alloy.

The first terminal plate 124 has a hole 124a, and the first terminal pillar 122 can be coupled to the hole 124a and riveted and/or welded. In one or more embodiments, facing surfaces between the upwardly exposed first terminal pillar 122 and the first terminal plate 124 may be welded to each other. In one or more embodiments, by providing a laser beam to a boundary area between the upwardly exposed first terminal pillar 122 and the first terminal plate 124, the boundary area may be melted and then cooled and welded. In one or more embodiments, the first terminal pillar 122 and the first terminal plate 124 may be electrically insulated from the cap plate 151.

The second current collection part 129 may be in contact with the second electrode tab 112a protruding to one end of the electrode assembly 110. In one or more embodiments, the second current collection part 129 may be formed in an approximately inverse L (¬)-letter shape, and a terminal hole 129a may be formed at a top portion thereof. In one or more embodiments, the second terminal pillar 132 is inserted and coupled to the terminal hole 129a. The second current collection part 129 may be made of, for example, but not limited to, aluminum or an aluminum alloy. The second terminal pillar 132 may pass through the cap plate 151 and protrude and extend upward for a certain length, which will be described later, and may be electrically connected to the second current collection part 129 at the lower portion of the cap plate 151.

The second terminal 130 may also be made of metal and may be electrically connected to the second electrode plate 112 through the second current collection part 129. In one or more embodiments, the second terminal 130 may include a second terminal pillar 132 and a second terminal plate 134.

The second terminal pillar 132 protrudes and extends a certain length to the upper part of the cap plate 151, and a flange 132a may be formed at the lower portion of the cap plate 151 to prevent the second terminal pillar 132 from falling out of the cap plate 151. The region of the second terminal pillar 132, located below the flange 132a, may be inserted into the second terminal hole 119a of the second current collection part 129 and then riveted and/or welded.

In one or more embodiments, the second terminal pillar 132 may be made of aluminum or an aluminum alloy. The second terminal plate 134 has a hole 134a. In addition, the second terminal plate 134 is coupled to the second terminal pillar 132. That is, the second terminal pillar 132 is coupled to the hole 134a of the second terminal plate 134. In addition, the second terminal pillar 132 and the second terminal plate 134 may be riveted and/or welded to each other. In one or more embodiments, a boundary area between the upwardly exposed second terminal pillar 132 and the second terminal plate 134 may be welded to each other. In one or more embodiments, by providing a laser beam to the boundary area between the upwardly exposed second terminal pillar 132 and the second terminal plate 134, the boundary area may be welded to each other by melting and cooling.

In one or more embodiments, the second terminal pillar 132 and the second terminal plate 134 may be electrically insulated from the cap plate 151. In one or more embodiments, the second terminal pillar 132 and the second terminal plate 134 may be electrically connected to the cap plate 151, and the cap plate 151 of the cap assembly may have the same polarity (e.g., a positive polarity) as the second terminal 130.

The case 140 accommodating the electrode assembly 110 may be shaped of a hollow rectangular parallelepiped with an opening formed at the top. The electrode assembly 110 may be inserted into the case 140 through the opening. In addition, the first current collection part 119 of the first terminal 120 and the second current collection part 129 of the second terminal 130 may also be located inside the case 140. The case 140 may include a rectangular bottom surface 141 and four side surfaces extending in an approximately upward-and-downward direction from the four sides of the bottom surface 141.

The case 140 may be molded by using flat aluminum having high ductility, and if the rigidity of the case 140 is reduced because the reinforcement unit 300 is not formed on the side surface 142 of the case 140, a swelling phenomenon, in which the shape is deformed by gas generated from the electrode assembly 110, etc., may occur.

The swelling phenomenon is one of the important safety issues of the secondary battery 100 or a lithium-ion battery. The swelling phenomenon may occur when the secondary battery 100 is charged or discharged, when the battery is used, and/or when the battery is stored at high temperature. Swelling mainly occurs in prismatic lithium-ion batteries. To prevent or at least mitigate against swelling, the case is molded by using reinforced aluminum, and the reinforcement unit 300 is installed on the side surface 142.

Swelling mainly occurs according to the following processes. During charging and discharging, lithium ions move from a positive electrode to a negative electrode. During this process, a chemical reaction occurs, and the chemical composition of the battery changes, and thus gas is generated and accumulated inside the case 140. The generated gas may increase the internal pressure of the secondary battery 100, and a swelling phenomenon in which the case 140 swells may occur.

During charging and discharging of the secondary battery 100, the thickness of the electrode assembly 110 increases or decreases according to the movement and chemical reaction of lithium ions in the electrode assembly 110, and thus a swelling phenomenon in which the case 140 swells may occur.

When swelling occurs, the thickness of the electrode assembly 110 increases, and thus the degree of adhesion between the case 140 and the electrode assembly 110 may decrease. Accordingly, a phenomenon in which metallic lithium penetrates a separator (lithium dendrite) may occur. In addition, the possibility of creating a short inside the electrode assembly 110 may be increased. This may cause a short circuit inside the battery. A short circuit inside the battery refers to a situation in which the internal components of the secondary battery 100 are not sufficiently insulated or the insulation is damaged such there is an electrical connection between the negative electrode and the positive electrode or between other internal components of the secondary battery 100. When an internal short circuit occurs, electricity flows abnormally, and high temperatures, unstable chemical reactions, and the risk of fire and explosion inside the secondary battery 100 may greatly increase.

For these reasons, it is important to prevent or at least mitigate the risk of the swelling phenomenon in the secondary battery 100. By providing high-strength protrusions or recessed structures aligned with each other on the side surface 142 of the case 140, according to the first embodiment of the present disclosure, the reinforcement unit 300 may suppress the swelling phenomenon of the secondary battery 100, and accordingly, improve the safety of the secondary battery 100.

The cap assembly 150 may be coupled to the case 140. In one or more embodiments, the cap assembly 150 may include the cap plate 151, a seal gasket 152, a plug 153, an upper coupling member 155, and an insulating member 156.

The cap plate 151 seals the opening of the case 140, which is open on at least one side, and may be made of the same material as the case 140. The case 140 may be modified in various ways, such as having both ends open or only one side open. Accordingly, the cap plate 151 may be modified in various ways to seal the open portion of the case 140.

In one or more embodiments, the cap plate 151 may be coupled to the case by laser welding, but the present disclosure is not limited thereto. In one or more embodiments, the cap plate 151 may have the same polarity as the second terminal as described above, and the cap plate 151 and the case 140 may have the same polarity. An electrolyte injection hole 151a and a vent hole 151b penetrating between the upper and lower surfaces of the cap plate 151 may be provided.

The seal gasket 152 is made of an insulating material and is installed (located) between the cap plate 151 and the first terminal pillar 122 of the first terminal and between the cap plate 151 and the second terminal pillar 130 of the second terminal 130, respectively. The seal gasket 152 seals portions between the first terminal pillar 122 and the cap plate 151 and between the second terminal pillar 132 and the cap plate 151. The seal gasket 152 prevents (or at least mitigates) external moisture from penetrating into the interior of the secondary battery 100 or prevents (or at least mitigates) the electrolyte contained within the secondary battery 100 from leaking out.

The plug 153 can seal the electrolyte injection hole 151a after the electrolyte is injected into the interior of the case 140 through the electrolyte injection hole 151a of the cap plate 151.

The upper coupling member 155 may be formed between the first terminal pillar 122 and the cap plate 151 and between the second terminal pillar 132 and the cap plate 151 at the top of the cap plate 151. In addition, the upper coupling member is in close contact with the cap plate 151. Moreover, the upper coupling member may also be in close contact with the seal gasket 152. The upper coupling member may insulate the first terminal pillar 122 and the second terminal pillar 132 from the cap plate 151 from each other. In one or more embodiments, the upper coupling member 155 interposed (located) between the second terminal plate 134 and the cap plate 151 and may electrically connect the second terminal plate 134 and the cap plate 151, and accordingly, the cap plate 151 may have the same polarity as the second terminal 130.

The insulating member 156 is shaped to correspond to the cap plate 151 and may be modified into various shapes between the cap plate 151 and the electrode assembly 110. The insulating member 156 is sized to approximately correspond to the bottom surface of the cap plate 151 and may be in close contact with the bottom surface of the cap plate 151. In one or more embodiments, the insulating member 156 may have an electrolyte injection hole 156a and a vent hole 156b formed at locations corresponding to the electrolyte injection hole 151a and the vent hole 151b formed in the cap plate 151. The insulating member 156 may prevent undesirable short circuits from occurring between the first current collection part 119 and the cap plate 151 and between the second current collection part 129 and the cap plate 151. In addition, the insulating member 156 6 is sized to correspond to the cap plate 151, thereby preventing undesirable short circuits between the electrode assembly 110 and the cap plate 151. In one or more embodiments, the insulating member 156 may be made of polyphenylene sulfide (PPS), which has a high melting point (285° C.) and high tensile strength, and as a result, when heat from an internal short circuit caused by penetration of the secondary battery 100 is released through the safety vent 200, heat propagation to adjacent cells can be prevented, thereby improving safety. The insulating member can prevent heat caused by an internal short circuit of the secondary battery 100 from being transferred to the adjacent secondary battery 100 through the cap assembly 150. In an embodiment in which the secondary battery 100 includes one unit cell, it may not be necessary to block heat propagation to the adjacent secondary battery 100, and thus polypropylene (PP) may also be applied to the insulating member 156.

The safety vent 200 is installed (located) at a position facing the vent hole b of the cap plate 151, and may be configured to be opened at a set pressure. The safety vent 200 is installed (located) in the cap plate 151 and may be modified into various shapes configured to close the vent hole 151b and to open the vent hole 151b to discharge gas.

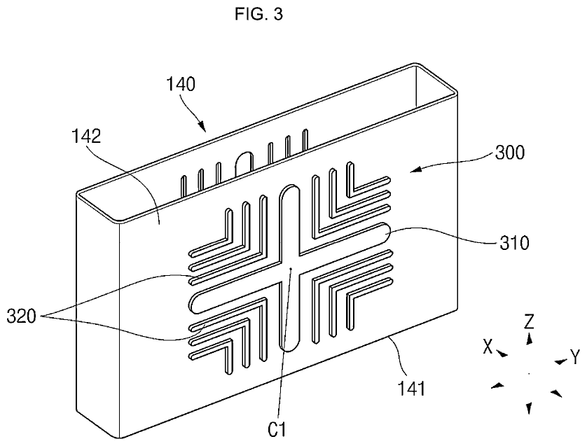

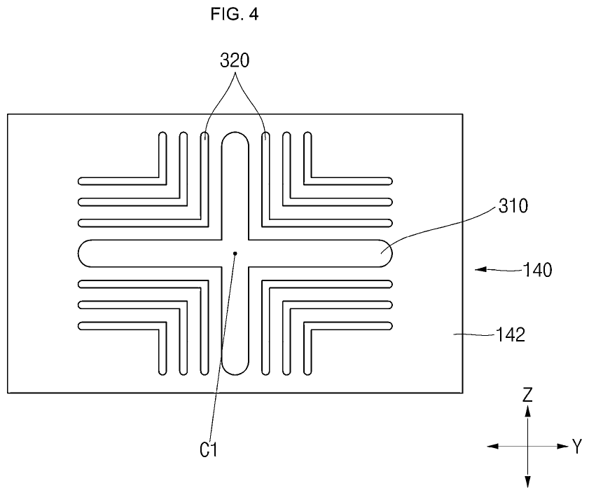

FIG. 3 is a perspective view showing a case 140 and a reinforcement unit according to the first embodiment of the present disclosure, and FIG. 4 is a front view showing the case 140 and the reinforcement unit 300 according to the first embodiment of the present disclosure. As shown in FIGS. 3 and 4, the reinforcement unit 300 may be modified into various shapes (e.g., an recessed or protruding shape) on the outer side surface of the case 140.

The reinforcement unit 300 in the case 140 is configured to suppress shape deformation, particularly a swelling phenomenon, of the secondary battery 100 using a rectangular lithium-ion battery (a prismatic lithium-ion battery). The case 140 is not limited to the case 140 having a rectangular parallelepiped shape, and the reinforcement unit 300 can be applied to various types of a case, including a cylindrical case.

The reinforcement unit 300 suppresses (or at least reduces) the swelling phenomenon of the case 140 and prevents (or at least mitigates) the swelling phenomenon by increasing the strength of the case 140. When the swelling phenomenon is prevented or reduced, the adhesion between an electrode and a separator is improved, thereby suppressing the formation of side reactants and metallic lithium. In addition, when the swelling phenomenon is prevented or reduced, the charging and discharging efficiency of the secondary battery 100 may be increased and minute shorts and hard shorts that may occur inside the secondary battery 100 may be prevented or at least reduced. Accordingly, the performance, reliability, and safety of the secondary battery 100 are improved, and the safety and reliability of a module or pack in which the secondary battery 100 is used are also improved.

In the reinforcement unit 300 according to one embodiment of the present disclosure, a recess (e.g., having a curved shape) may be applied to two to five surfaces of the case 140 where terminals or electrical terminals are not located. The recess may have various combinations of width, depth, length, and shape. According to the first embodiment of the present disclosure, the reinforcement unit 300 in the recess has a width in a range of approximately 0.1 mm—approximately 30 mm, a depth in a range of approximately 0.05 mm—approximately 5 mm, and a length in a range of approximately 30% to approximately 90% of the length of the case 140 in the x, y, and z axes. In addition, the case 140 may be molded from aluminum or stainless steel (SUS). The case 140 having the reinforcement unit 300 installed therein prevents (or at least mitigates) swelling of the case 140 and maintains adhesion between the case 140 and the electrode assembly 110 and the internal parts of the electrode assembly 110, and thus the safety and performance of the secondary battery 100 can be improved.

The reinforcement unit 300 may be formed in an recessed shape in which a groove is inwardly formed in the case 140, or may be shaped of a protrusion that protrudes outward from the case 140. The reinforcement unit 300 may include a combination of recessed and protruding shapes. In addition, the reinforcement unit 300 may have various shapes, such as a straight shape, a cross shape, an X-letter shape, an inverse L (¬)-letter shape, an L-letter shape, a polygonal shape, or combinations thereof.

The secondary battery 100 having the reinforcement unit 300 installed therein has charging and discharging efficiency of approximately 98% or greater, and heat generation of the secondary battery 100 is within a range equal to or less than approximately 5° C. In addition, in the secondary battery 100, not greater than approximately 1% of side reactants are precipitated during 10 charge/discharge cycles from the initial charge/discharge state (Beginning of Life (BOL)). If too many side reactants are precipitated, a safety-related issue may occur to the secondary battery 100, and thus less than approximately 1% of side reactants may be precipitated.

In addition, in the secondary battery 100 according to the first embodiment of the present disclosure, less than approximately 1% of side reactants are precipitated during 10 charge/discharge cycles from the initial charge/discharge state (Beginning of Life (BOL)). If too many side reactants are precipitated, a battery safety problem may be caused, and thus less than approximately 1% of side reactants may be precipitated.

The reinforcement unit 300 may include a first reinforcement member 310 that forms a pattern on the outer side of the case 140 in a recessed or protruding shape, and second reinforcement members 320 that form a pattern on the outer side of the case 140 in a different shape from the first reinforcement member 310. As shown in the embodiment depicted in FIG. 3, the first reinforcement member 310 and the second reinforcement members 320 may be shaped of protrusions protruding outward from the case 140.

The first reinforcement member 310 may include a cross-shaped protrusion. The first reinforcement member 310 is shaped of a protrusion that protrudes outward from the case 140 from the side surface 142 of the case 140, and the protrusion may be formed in a cross shape. In one or more embodiments, the shape of the first reinforcement member 310 may be modified into various shapes such as a circular or oval shape.

The second reinforcement members 320 may include a plurality of protrusions and/or recesses on the outer side the first reinforcement member 310. As an example, the second reinforcement members 320 may be provided with a plurality of protrusions bent in the inverse L-letter (“¬”) and L-letter shapes.

In an embodiment in which the first reinforcement member 310 is formed in a cross-shape, four installation areas (e.g., quadrants) are provided around a center point C1 of the first reinforcement member 310, which is the center of the first reinforcement member 310. Therefore, protrusions shaped in the inverse L-letter (¬) shape are located in the two installation areas (quadrants) located below the center point C1 of the first reinforcement member 310. The protrusions in the inverse L-letter (“¬”) shape are installed so that the apexes thereof are directed (pointed) toward the center point C1 of the first reinforcement member 310.

The second reinforcement members 320 are provided in two or more protrusions and/or recesses, and the sizes of the second reinforcement members 320 may gradually increase in a direction getting closer to the center point C1 of the first reinforcement member 310. In one or more embodiments in which three second reinforcement members 320 are installed on the outer side of the first reinforcement member 310, the second reinforcement member 320 that is farthest from the center point C1 of the first reinforcement member 310 is formed to be relatively small in size. In addition, the second reinforcement members 320 that are close to the center point C1 of the first reinforcement member 310 are formed to be larger in size than the second reinforcement members 320 that are far from the center point C1 of the first reinforcement member 310.

The widths of the protrusions of the first reinforcement member 310 and the second reinforcement member 320 may be in a range from approximately 0.1 mm to approximately 30 mm, and the depths thereof may be in range from approximately 0.05 mm to approximately 5 mm. The width of a protruding band shape in the first reinforcement member 310 is larger than the width of a protruding band shape in each second reinforcement member 320. Therefore, in one or more embodiments, the first reinforcement member 310 can reinforce the rigidity of the case 140 more than the second reinforcement members 320.

In one or more embodiments, the second reinforcement members 320 are smaller in size than the first reinforcement member 310, but are installed in greater numbers around the first reinforcement member 310, and thus the second reinforcement members 320 can reinforces the rigidity of the case 140 along with the first reinforcement member 310, thereby preventing or reducing the swelling phenomenon.

The first reinforcement member 310 and the second reinforcement members may be formed on a plurality of surfaces of the outer side surface 142 of the case 140. The reinforcement unit 300 may be formed on each of the front and rear sides, which are the long side surfaces 142 of the case 140, among the side surfaces 142 of the case 140, and various modifications are possible in which the reinforcement unit may be installed in other areas, except portions where terminals are located.

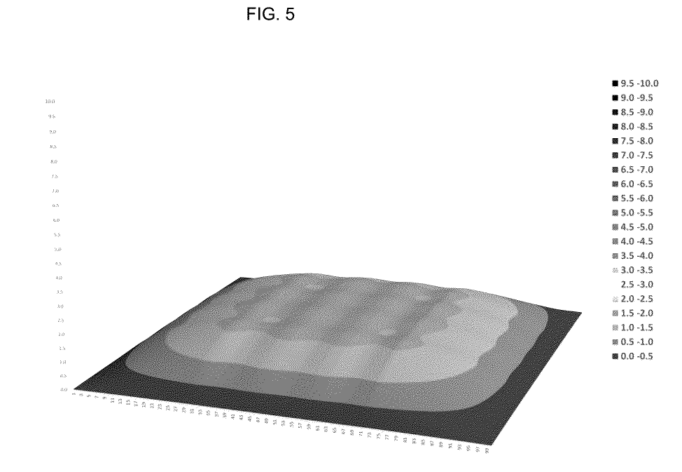

FIG. 5 is a diagram showing swelling changes according to the safety performance test of the case 140, according to the first embodiment of the present disclosure. As shown in FIG. 5, the amount of swelling displacement is measured by testing the case 140 to which the reinforcement unit 300 according to the first embodiment of the present disclosure is applied.

In an embodiment in which the reinforcement unit 300 includes the first reinforcement member 310 and the second reinforcement members 320 and forms a composite pattern, the maximum displacement of the case 140 is approximately 1.7 mm. This suggests that the rigidity of the case 140 is markedly improved, considering that the displacement of the case 140 without the reinforcement unit 300 installed is approximately 4.2 mm.

To obtain the test results depicted in the diagram of FIG. 5, life performance tests were performed at 10° C., 25° C., and 45° C., tests of being left at a high temperature of 60° C. were conducted, and an abnormal heating safety performance test was conducted at 55° C.

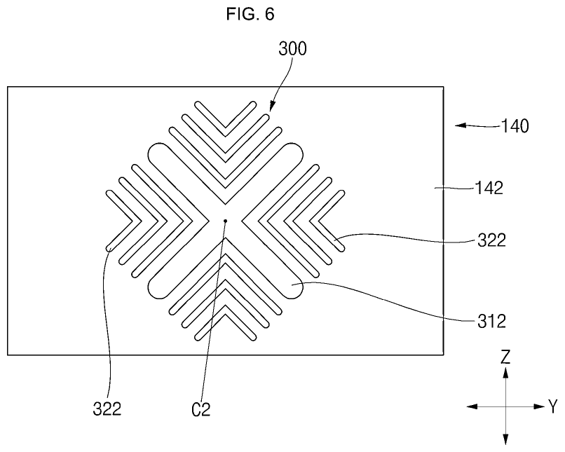

FIG. 6 is a front view showing a case 140 and a reinforcement unit 300, according to a second embodiment of the present disclosure. As shown in FIG. 6, according to the second embodiment of the present disclosure, the reinforcement unit includes a first reinforcement member 312 and second reinforcement members 322. The first reinforcement member 312 includes an X-shaped protrusion and is connected to the side surfaces 142 of the case 140 to reinforce the structural rigidity of the case 140.

The second reinforcement members 322 are located up, down, left, and right with respect to a center point C2 of the first reinforcement member 312, and include two or more reinforcement members 322. The width of the protrusion of the first reinforcement member 312 and the second reinforcement members 322 may be in a range from approximately 0.1 mm to approximately 30 mm, and the depths thereof may be in a range from approximately 0.05 mm to approximately 5 mm.

The second reinforcement members 322 may be shaped of inequality signs such as “<” or “>”. The vertexes of the second reinforcement members 322 are installed (pointed) toward the center point C2 of the first reinforcement member 312. The second reinforcement members 322 are provided in two or more protrusions and/or recesses, and the sizes of the second reinforcement members 322 may gradually increase in a direction getting closer to the center point C2 of the first reinforcement member 312.

The main functions and effects of the reinforcement unit 300 are the same or similar to those in the first embodiment of the present disclosure, and thus detailed descriptions thereof will be omitted.

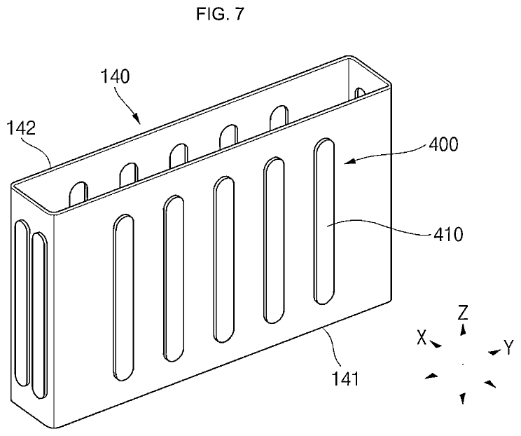

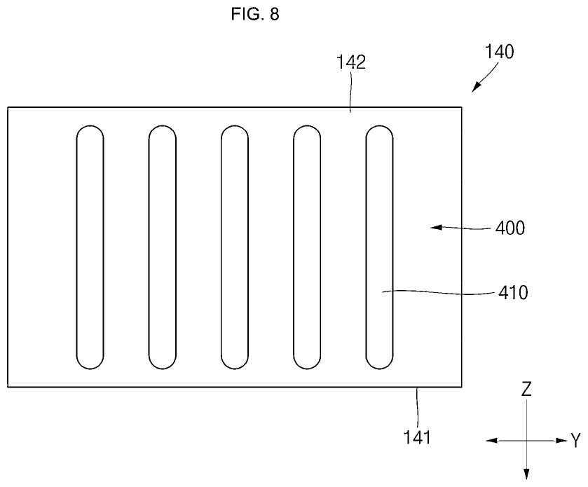

FIG. 7 is a perspective view showing a case 140 and a reinforcement unit according to a third embodiment of the present disclosure, and FIG. 8 is a front view showing the case 140 and the reinforcement unit 400 according to the third embodiment of the present disclosure. As shown in FIGS. 7 and 8, the reinforcement unit 400 has a plurality of reinforcement members 410 formed on the outer side surface of the case 140. The reinforcement members 410 may extend in the upward-and-downward direction (Z) of the case 140.

According to the third embodiment of the present disclosure, the reinforcement members 410 extend in the upward-and-downward direction (Z) of the case 140 and are each shaped of a protrusion that protrudes outward from the case 140. The reinforcement members 410 may be provided in two or more protrusions along the lengthwise direction (Y) of the case 140. The reinforcement members 410 may be formed in a plurality of rows along the lengthwise direction (Y). The height in which the reinforcement members 410 protrude in the case 140 may be in a range from approximately 0.05 mm to approximately 5 mm. The reinforcement members 410 may be formed on multiple sides of the outer side surface 142 of the case 140.

The reinforcement unit 400 may be formed on each of the front and rear sides, which are the long side surfaces 142 of the case 140, and various modifications are possible in which the reinforcement unit 400 may be installed in other areas, except portions where terminals are located.

The main functions and effects of the reinforcement unit 400 are the same or similar to those in the first embodiment of the present disclosure, and thus detailed descriptions thereof will be omitted.

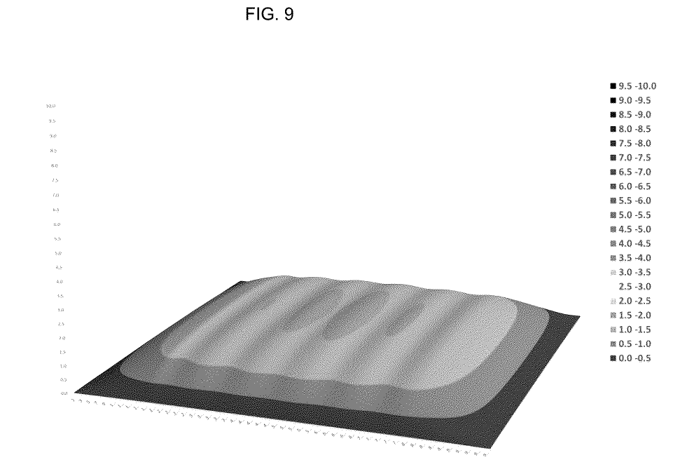

FIG. 9 is a diagram showing swelling changes according to the safety performance test of the case 140 according to the third embodiment of the present disclosure. As shown in FIG. 9, the amount of swelling displacement is measured by testing the case 140 to which the reinforcement unit 400 according to the third embodiment of the present disclosure is applied.

In an embodiment in which the reinforcement unit 400 is a protrusion extending in the upper and lower direction (Z), the maximum displacement of the case is approximately 1.6 mm. This suggests that the rigidity of the case 140 is significantly improved, considering that the displacement of the case 140 without the reinforcement unit 400 installed is approximately 4.2 mm.

To obtain the test results depicted in the diagram of FIG. 9, life performance tests were performed at 10° C., 25° C., and 45° C., tests of being left at a high temperature of 60° C. were conducted, and an abnormal heating safety performance test was conducted at 55° C.

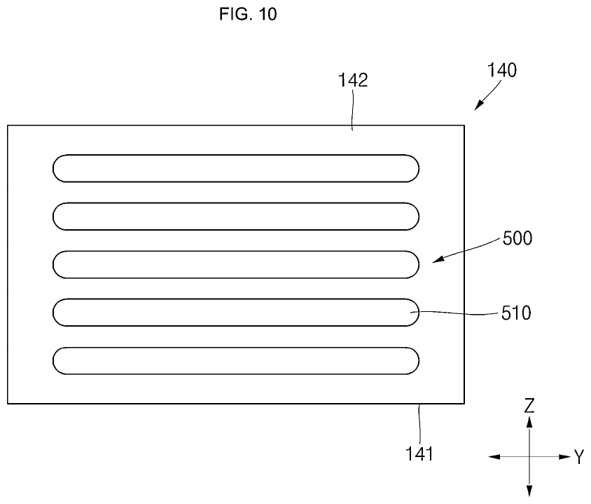

FIG. 10 is a front view showing a case 140 and a reinforcement unit 500 according to a fourth embodiment of the present disclosure. As shown in FIG. 10, the reinforcement unit 500 has a plurality of reinforcement members 510 formed on the outer side surface of the case 140. The reinforcement members 510 may extend in the lengthwise direction (Y) of the case 140.

According to the fourth embodiment of the present disclosure, the reinforcement members 510 extend in the lengthwise direction (Y) of the case 140 and are protrusions that protrude outward from the case 140. The reinforcement members may be provided in two or more protrusions along the upward-and-downward direction (Z) of the case 140. The reinforcement members 510 may be formed in a plurality of rows along the upward-and-downward direction (Z). The height in which the reinforcement members 510 protrude in the case 140 may be in a range from approximately 0.05 mm to approximately 5 mm. The reinforcement members 510 may be formed on multiple sides of the outer side surface 142 of the case 140.

The reinforcement unit 500 may be formed on each of the front and rear sides, which are the long side surfaces 142 of the case 140, and various modifications are possible in which the reinforcement unit 500 may be installed in other areas, except portions where terminals are located.

The main functions and effects of the reinforcement unit 500 are the same or similar to those in the first embodiment of the present disclosure, and thus detailed descriptions thereof will be omitted.

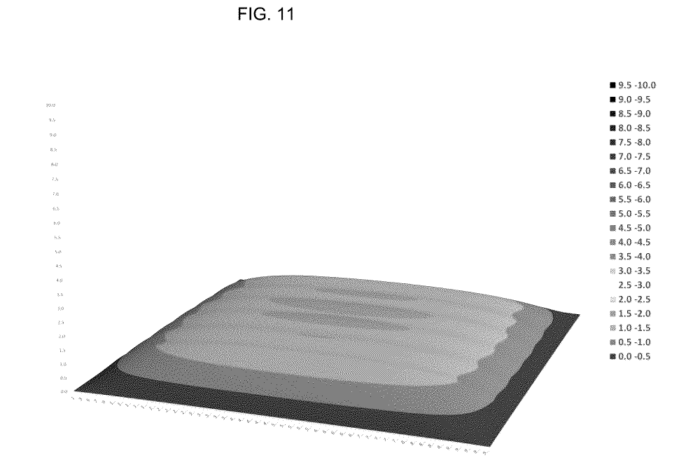

FIG. 11 is a diagram showing swelling changes according to the safety performance test of the case 140 according to the fourth embodiment of the present disclosure. As shown in FIG. 11, the amount of swelling displacement is measured by testing the case 140 to which the reinforcement unit 500 according to the fourth embodiment of the present disclosure is applied.

In an embodiment in which the reinforcement unit 500 is a protrusion that extends in the horizontal direction, the maximum displacement of the case 140 is approximately 1.6 mm. This suggests that the rigidity of the case 140 is markedly improved, considering that the displacement of the case 140 without the reinforcement unit 500 installed is approximately 4.2 mm.

To obtain the test results depicted in the diagram of FIG. 11, life performance tests were performed at 10° C., 25° C., and 45, tests of being left at a high temperature of 60° C. was conducted, and an abnormal heating safety performance test was conducted at 55° C.

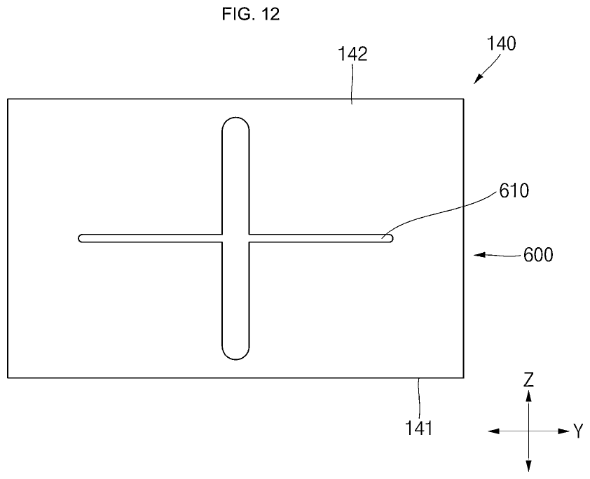

FIG. 12 is a front view showing a case 140 and a reinforcement unit 600, according to a fifth embodiment of the present disclosure. As shown in FIG. 12, the reinforcement unit 600 has a single reinforcement member 610 formed on the outer surface of the case 140. The reinforcement member 610 forms a cross-shaped protrusion outer side of the case 140.

According to the fifth embodiment of the present disclosure, the reinforcement member 610 may include a cross-shaped protrusion. The reinforcement member 610 is a protrusion that protrudes outward from the case 140 from the side surface 142 of the case 140, and the protrusion may be formed in a cross shape. In one or more embodiments, the shape of the first reinforcement member 610 may be modified into various shapes such as a circular or oval shape.

The height in which the reinforcement member 610 protrudes in the case 140 may be in a range from approximately 0.05 mm to approximately 5 mm. The reinforcement member 610 may be formed on multiple sides of the outer side surface of the case 140. The reinforcement unit 600 may be formed on each of the front and rear sides, which are the long side surfaces 142 of the case 140, and various modifications are possible in which the reinforcement unit 600 may be installed in other areas, except portions where terminals are located.

The main functions and effects of the reinforcement unit 600 are the same or similar to those in the first embodiment of the present disclosure, and thus detailed descriptions thereof will be omitted.

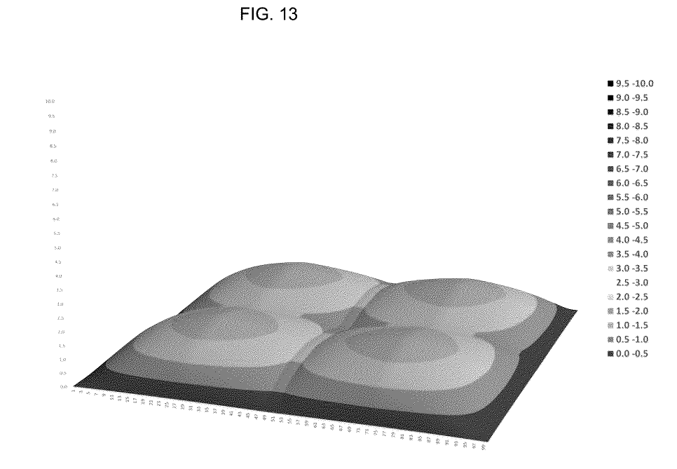

FIG. 13 is a diagram showing swelling changes according to the safety performance test of the case 140 according to the fifth embodiment of the present disclosure. As shown in FIG. 13, the amount of swelling displacement is measured by testing the case 140 to which the reinforcement unit 600 according to the fifth embodiment of the present disclosure is applied.

When the reinforcement unit 600 is shaped of a protrusion that extends in the horizontal direction, the maximum displacement of the case 140 is approximately 1.8 mm. This suggests that the rigidity of the case 140 is markedly improved, considering that the displacement of the case 140 without the reinforcement unit 600 installed is approximately 4.2 mm.

To obtain the test results depicted in the diagram of FIG. 13, life performance tests were performed at 10° C., 25° C., and 45, tests of being left at a high temperature of 60° C. were conducted, and an abnormal heating safety performance test was conducted at 55° C.

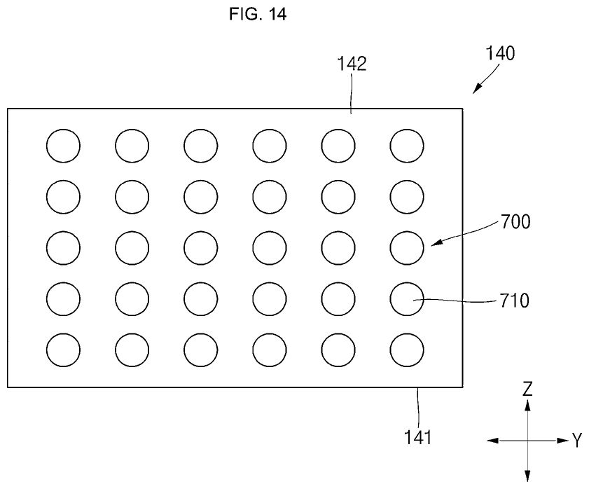

FIG. 14 is a front view showing a case 140 and a reinforcement unit 700 according to a sixth embodiment of the present disclosure. As shown in FIG. 14, the reinforcement unit 700 has reinforcement members 710 formed on the outer surface of the case 140. The reinforcement members 710 are protrusions that protrude outward from the case 140. According to the sixth embodiment of the present disclosure, the reinforcement members 710 may include circular protrusions. The reinforcement members 710 may be shaped of circular protrusions and may be provided in two or more protrusions. The reinforcement members 710 according to the sixth embodiment of the present disclosure are arranged in rows and columns within a rectangular area.

The reinforcement members 710 have protrusions shaped of hemispherical or circular beads and may be installed on multiple sides of the side surface 142 of the case 140.

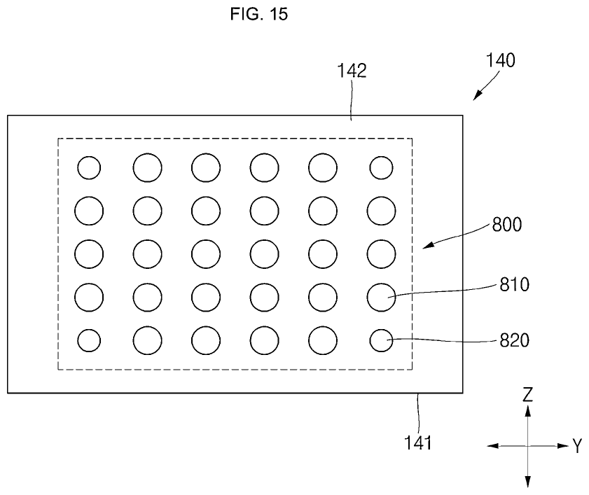

FIG. 15 is a front view showing a case 140 and a reinforcement unit 800 according to a seventh embodiment of the present disclosure. As shown in FIG. 15, according to the seventh embodiment of the present disclosure, the reinforcement unit has third reinforcement members 810 and fourth reinforcement members 820 formed on the outer surface of the case 140. The third reinforcement members 810 and the fourth reinforcement members 820 are protrusions that protrude outward from the case 140. The third reinforcement members 810 and the fourth reinforcement members according to the seventh embodiment of the present disclosure include circular protrusions. The third reinforcement members 810 and the fourth reinforcement members 820 include circular protrusions and are provided in two or more protrusions. The third reinforcement members 810 and the fourth reinforcement members 820, according to the seventh embodiment of the present disclosure, may be arranged in rows and columns within a rectangular area (L). The third reinforcement members 810 and the fourth reinforcement members 820 include protrusions shaped of hemispherical or circular beads and may be installed on multiple sides of the side surface 142 of the case 140.

In the seventh embodiment of the present invention, the fourth reinforcement members 820 installed at the corners of the rectangular area (L) may be smaller in size (e.g., diameter) than the third reinforcement members 810 installed in areas other than the corners of the rectangular area (L). Since the fourth reinforcement members 820 are formed to be small in size, the interference with the outer side of the secondary battery 100 may be reduced.

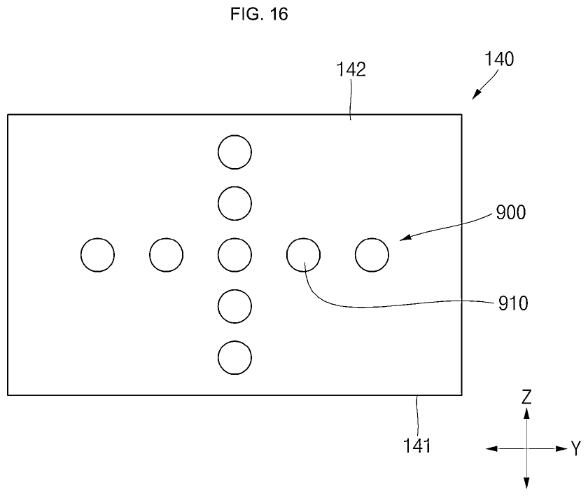

FIG. 16 is a front view showing a case 140 and a reinforcement unit 900 according to an eighth embodiment of the present disclosure. As shown in FIG. 16, according to the eighth embodiment of the present disclosure, the reinforcement unit 900 has a plurality of reinforcement members 910 formed on the outer surface of the case 140. The reinforcement members 910 are protrusions that protrude outward from the case 140. The reinforcement members 910 according to the eighth embodiment of the present disclosure may include circular protrusions. The reinforcement members may be shaped of circular protrusions and may be provided in two or more protrusions. The reinforcement members 910 may include protrusions shaped of hemispherical or circular beads and may be installed on multiple sides of the side surface 142 of the case 140. In addition, the reinforcement members 910 may be arranged in a cross shape.

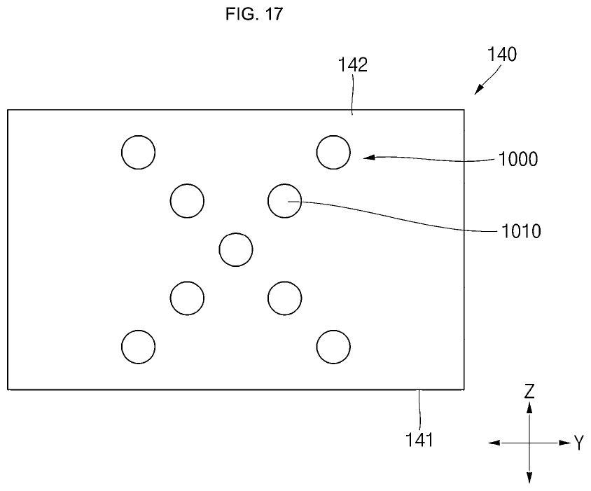

FIG. 17 is a front view showing a case 140 and a reinforcement unit 1000, according to a ninth embodiment of the present disclosure. As shown in FIG. 17, according to the ninth embodiment of the present disclosure, the reinforcement unit may have a plurality of reinforcement members 1010 formed on the outer surface of the case 140. The reinforcement members 1010 are protrusions that protrude outward from the case 140. The reinforcement members 1010 according to the ninth embodiment of the present disclosure may include circular protrusions. The reinforcement members 1010 according to the ninth embodiment of the present disclosure may include protrusions shaped of hemispherical or circular beads and may be installed on multiple sides of the side surface 142 of the case 140. In addition, the reinforcement members 1010 may be arranged in an X-letter shape.

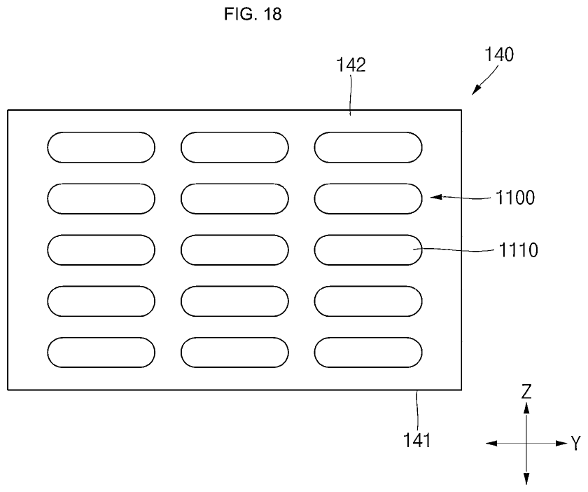

FIG. 18 is a front view showing a case 140 and a reinforcement unit 1100 according to a tenth embodiment of the present disclosure. As shown in FIG. 18, according to the tenth embodiment of the present disclosure, the reinforcement unit may have reinforcement members 1110 formed on the outer surface of the case 140. The reinforcement members 1110 are protrusions that protrude outward from the case 140. The reinforcement members 1110 according to the tenth embodiment of the present disclosure are straight protrusions extending in the lengthwise direction (Y) of the case 140 (e.g., oval or elongated protrusions oriented in the lengthwise direction (Y)), and the reinforcement members 1110 are provided in two or more protrusions. The reinforcement members 1110 according to the tenth embodiment of the present disclosure may be arranged in rows and columns within a rectangular area.

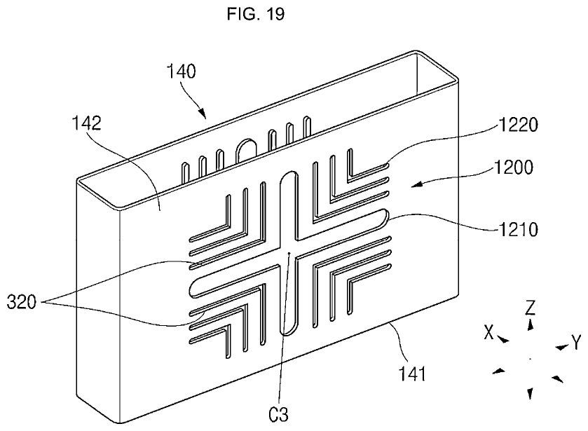

As shown in FIG. 19, the reinforcement unit 1100 according to an eleventh embodiment of the present disclosure may include a first reinforcement member 1210 that forms a pattern on the outer side of the case 140 in a recessed shape, and second reinforcement members 1220 that form a pattern on the outer side of the case 140 in a different shape from the first reinforcement member 310. As shown in FIG. 19, the first reinforcement member 1210 and the second reinforcement members 1220 may have grooves inwardly formed in the case 140.

The first reinforcement member 1210 has a groove formed in a cross shape. The first reinforcement member 1210 is shaped of a band that forms a groove inwardly formed in the case 140 from the side surface 142 of the case 140, and may be formed in a cross shape. In one or more embodiments, the first reinforcement member 1210 may be modified into various shapes such as a circular or oval shape.

The second reinforcement members 1220 may be provided in two or more recesses on the outer side the first reinforcement member 1210. In one or more embodiments, the second reinforcement members 1220 may include two or more recesses (e.g., grooves) bent in the inverse L-letter (¬) and L-letter shapes.

In an embodiment in which the first reinforcement member 310 is formed in a cross-shape, four installation areas (e.g., quadrants) are provided around a center point C3 of the first reinforcement member 1210, which is the center of the first reinforcement member 1210. Therefore, grooves curved in the inverse L-letter (¬) shape are located in the two installation areas (lower quadrants) located below the center point C3 of the first reinforcement member 1210. The grooves in the inverse L-letter (“¬”) shape are installed so that the apexes thereof are directed toward the center point C3 of the first reinforcement member 1210.

The second reinforcement members 1220 include two or more recesses (e.g., grooves) and the sizes of the second reinforcement members 1220 may gradually increase in a direction getting closer to the center point C3 of the first reinforcement member 1210. In one or more embodiments, when three second reinforcement members 1220 are installed on the outer side of the first reinforcement member 1210, the second reinforcement member 1220 that is farthest from the center point C3 of the first reinforcement member 1210 has a relatively small in size. In addition, the second reinforcement members 1220 that are closer to the center point C3 of the first reinforcement member 1210 have a relatively larger in size than the second reinforcement members 1220 that are farther from the center point C3 of the first reinforcement member 1210.

As described above, according to the present disclosure, by reinforcing the rigidity of a case, deformation of the case can be prevented, thereby improving the durability of a secondary battery.

In addition, in the present disclosure, by changing the shape of a case, the adhesion between various parts of an electrode assembly can be improved, thereby improving the charging and discharging efficiency of a secondary battery, and by reducing the heat generation of the battery, the occurrence of short circuits can be reduced.

However, the effects that can be attained through the present disclosure are not limited to those mentioned above, and other technical effects that are not mentioned can be clearly understood by those skilled in the art from the description of the invention described below.

Although the present disclosure has been explained by limited examples and drawings, the present disclosure is not limited thereto, and various modifications and variations can be made by a person skilled in the art to which the present disclosure belongs within the scope of equivalence between the technical idea of the present disclosure and the scope of the patent claims described below.

What is claimed is:

1. A secondary battery comprising:
an electrode assembly comprising a first electrode plate, a second electrode plate, and a separator;
a case accommodating the electrode assembly; and
a reinforcement unit on an outer side surface of the case, the reinforcement unit having a recessed or protruding shape,
wherein the reinforcement unit comprises:
a first reinforcement member in a first pattern on the outer side of the case; and
a second reinforcement member in a second pattern on the outer side of the case, the second reinforcement member having a different shape than the first reinforcement member.

2. The secondary battery as claimed in claim 1, wherein the first reinforcement member and the second reinforcement member are protrusions protruding from the outer side of the case.

3. The secondary battery as claimed in claim 1, wherein the first reinforcement member comprises a cross-shaped or X-letter shaped protrusion.

4. The secondary battery as claimed in claim 3, wherein the second reinforcement member comprises a plurality of second reinforcement members around the first reinforcement member.

5. The secondary battery as claimed in claim 3, wherein the second reinforcement member comprises a plurality of protrusions in inverse L-letter and L-letter shapes.

6. The secondary battery as claimed in claim 3, wherein the second reinforcement member comprises a plurality of second reinforcement members, and wherein sizes of the plurality of second reinforcement members gradually increase in a direction toward a center of the first reinforcement member.

7. The secondary battery as claimed in claim 1, wherein the first reinforcement member and the second reinforcement member are on multiple sides of the outer side surface of the case.

8. The secondary battery as claimed in claim 1, wherein widths of the first reinforcement member and the second reinforcement member are each in a range from approximately 0.1 mm to approximately 30 mm, and wherein depths of the first reinforcement member and the second reinforcement member are each in a range from approximately 0.05 mm to approximately 5 mm.

9. A secondary battery comprising:
an electrode assembly comprising a first electrode plate, a second electrode plate, and a separator;
a case accommodating the electrode assembly; and
a reinforcement unit comprising at least one reinforcement member on an outer side surface of the case,
wherein the at least one reinforcement member extends in a lengthwise direction or an upward-and-downward direction of the case.

10. The secondary battery as claimed in claim 9, wherein the at least one reinforcement member extends in the lengthwise direction of the case and comprises a plurality of protrusions protruding outward from the case

11. The secondary battery as claimed in claim 9, wherein the at least one reinforcement member extends in the upward-and-downward direction of the case and comprises a plurality of protrusions protruding outward from the case.

12. A secondary battery comprising:
an electrode assembly comprising a first electrode plate, a second electrode plate, and a separator;
a case accommodating the electrode assembly; and
a reinforcement unit comprising a plurality of reinforcement members protruding outward from an outer side surface of the case,
wherein the plurality of reinforcement members comprises circular or straight-shaped protrusions.

13. The secondary battery as claimed in claim 12, wherein the plurality of reinforcement members comprises a plurality of circular protrusions.

14. The secondary battery as claimed in claim 13, wherein the plurality of reinforcement members is arranged in a cross or X-letter shape.

15. The secondary battery as claimed in claim 13, wherein the plurality of reinforcement members is arranged in rows and columns within a rectangular area.

16. The secondary battery as claimed in claim 15, wherein reinforcement members of the plurality of reinforcement members located at corners of the rectangular area are smaller in size than other reinforcement members of the plurality of reinforcement members not located at the corners of the rectangular area.

17. The secondary battery as claimed in claim 12, wherein a height at which the plurality of reinforcement members protrude from the case is in a range from approximately 0.05 mm to approximately 5 mm.

18. The secondary battery as claimed in claim 12, wherein the plurality of reinforcement members extends in a horizontal direction.

19. The secondary battery as claimed in claim 18, wherein the plurality of reinforcement members is arranged in rows and columns within a rectangular area.

20. The secondary battery as claimed in claim 12, wherein the plurality of reinforcement members are on multiple sides of the outer side surface of the case.
